(19) United States
(12) Patent Application Publication
(10) Pub. No.: US 2026/0281747 A1
(43) Pub. Date: Sep. 17, 2026

(54) AI MODEL PROCESSING METHOD, NETWORK DEVICE, USER EQUIPMENT, AND COMMUNICATION SYSTEM

(71) Applicant: Beijing Xiaomi Mobile Software Co., Ltd., Beijing (CN)

(72) Inventors: Xing YANG, Beijing (CN); Xiaolong LI, Beijing (CN)

(73) Assignee: Beijing Xiaomi Mobile Software Co., Ltd., Beijing (CN)

(21) Appl. No.: 19/579,035

(22) PCT Filed: Oct. 17, 2023
(86) PCT No.: PCT/CN2023/125015

§ 371 Date: Apr. 16, 2026

(51) Int. Cl. H04W 24/02; H04L 41/16

(52) U.S. Cl. CPC H04W 24/02; H04L 41/16

(57) ABSTRACT

Embodiments of the present disclosure relate to an AI model processing method, a network device, a user equipment (UE), and a communication system. The AI model processing method is applied to a first network device. The method includes: sending an AI model transmission request to a UE, the AI model transmission request including parameter information of an AI model; receiving an AI model transmission response fed back by the UE; and on the basis of the AI model transmission response, determining whether to transmit the AI model.

### CROSS-REFERENCE TO RELATED APPLICATION

The present application is a National Stage of International Application No. PCT/CN2023/125015, filed on Oct. 17, 2023, the entire disclosure of which is incorporated herein by reference for all purposes.

### TECHNICAL FIELD

This disclosure relates to the field of communication technology, and more particularly to an AI model processing method, a network device, a user equipment, and a communication system.

### BACKGROUND

With the development of mobile communication systems, Artificial Intelligence (AI) will be widely applied in communication systems, such as fields of image processing and speech recognition, or the like. More and more applications based on artificial intelligence neural network models (also known as AI models) will be deployed on terminal devices. In the 5th Generation Mobile Communication Technology (5G) system, AI can be used for prediction and inference, to improve system performance. Therefore, it is necessary to further improve the application mechanism of AI models in 5G systems.

### SUMMARY

This disclosure provides an AI model processing method, a network device, a user equipment, and a communication system.

On one hand, embodiments of this disclosure provide an AI model processing method, applied to a first network device, the method including: sending an AI model transmission request to a user equipment (UE), wherein the AI model transmission request includes parameter information of the AI model;
receiving an AI model transmission response fed back by the UE; and determining whether to transmit the AI model based on the AI model transmission response.

On the other hand, embodiments of this disclosure also provide an AI model processing method, applied to a user equipment (UE), the method including:
receiving an AI model transmission request sent by a first network device, wherein the AI model transmission request includes parameter information of the AI model; and feeding back an AI model transmission response to the first network device.

On the other hand, embodiments of this disclosure also provide an AI model processing method, applied to a first network device, the method including:
receiving capability change information sent by a user equipment (UE), wherein the capability change information includes capability information after AI capability of the UE changes upon receiving the AI model transmitted by another network device.

On the other hand, embodiments of this disclosure also provide an AI model processing method, applied to a user equipment (UE), including:
sending capability change information of the UE to a first network device, after receiving an AI model transmitted by another network device, wherein the capability change information includes capability information after AI capability of the UE changes.

On the other hand, embodiments of this disclosure also provide an AI model processing method, applied to a first network device, the method including:
receiving capability change information of a user equipment (UE), and forwarding the capability change information to a second network device, wherein the capability change information includes capability information after AI capability of the UE changes.

On the other hand, embodiments of this disclosure also provide an AI model processing method, applied to a user equipment (UE), the method including:
sending capability change information of the UE to a third network device, indicating the third network device to forward the capability change information to a second network device, wherein the capability change information includes capability information after AI capability of the UE changes.

On the other hand, embodiments of this disclosure also provide a network device, the network device being a first network device, the network device including:
a request sending module, configured to send an AI model transmission request to a user equipment (UE), wherein the AI model transmission request includes parameter information of the AI model;
a response receiving module, configured to receive an AI model transmission response fed back by the UE; and
a transmission determining module, configured to determine whether to transmit the AI model based on the AI model transmission response.

On the other hand, embodiments of this disclosure also provide a user equipment, including:
a request receiving module, configured to receive an AI model transmission request sent by a first network device, wherein the AI model transmission request includes parameter information of the AI model; and
a response sending module, configured to feed back an AI model transmission response to the first network device.

On the other hand, embodiments of this disclosure also provide a network device, the network device is a first network device, and includes:
one or more processors,
wherein the network device is configured to execute the AI model processing method described in the embodiments of this disclosure.

On the other hand, embodiments of this disclosure also provide a user equipment, including: one or more processors,
wherein the user equipment is configured to execute the AI model processing method described in the embodiments of this disclosure.

The embodiments of the disclosure also provide a communication system, including a network device and a user equipment (UE); wherein the network device is configured to implement the AI model processing method described in the embodiments of this disclosure, and the UE is configured to implement the AI model processing method described in the embodiments of this disclosure.

This disclosure also provides a storage medium storing instructions that, when executed on a communication device, cause the communication device to execute the AI model processing method described in the embodiments of this disclosure.

Additional aspects and advantages of embodiments of this disclosure will be set forth in part in the following description, and will be obvious from the description, or may be learned by practice of this disclosure.

### BRIEF DESCRIPTION OF THE DRAWINGS

To more clearly illustrate the technical solutions of the embodiments of this disclosure, the accompanying drawings used in the description of the embodiments will be introduced below. The drawings described below are merely some embodiments of this disclosure and do not impose specific limitations on the protection scope of this disclosure.

FIG. 1 is an example schematic diagram of the architecture of a communication system provided according to an embodiment of this disclosure;

FIG. 2 is one of the interactive schematic diagrams of an example provided according to an embodiment of this disclosure;

FIG. 3 is another interactive schematic diagram of an example provided according to an embodiment of this disclosure;

FIG. 4 is still another interactive schematic diagram of an example provided according to an embodiment of this disclosure;

FIG. 5 is one of the flowcharts of an AI model processing method provided according to an embodiment of this disclosure;

FIG. 6 is another flowchart of an AI model processing method provided according to an embodiment of this disclosure;

FIG. 7 is a structural schematic diagram of a first network device proposed in an embodiment of this disclosure;

FIG. 8 is a structural schematic diagram of a user equipment proposed in an embodiment of this disclosure;

FIG. 9 is a structural schematic diagram of a terminal proposed in an embodiment of this disclosure;

FIG. 10 is a structural schematic diagram of a chip proposed in an embodiment of this disclosure.

### DETAILED DESCRIPTION

The embodiments of this disclosure propose an AI model processing method, a network device, a user equipment (UE), and a communication system.

In a first aspect, the embodiments of this disclosure propose an AI model processing method applied to a first network device. The method includes:
sending an AI model transmission request to a user equipment UE, wherein the AI model transmission request includes parameter information of the AI model;
receiving an AI model transmission response fed back by the UE; and determining whether to transmit the AI model based on the AI model transmission response.

In the above embodiments, the network device can learn about the dynamically changing capability of the UE regarding the storage and operation of the AI model before transmitting the AI model, thereby avoiding the problem of being unable to store the AI model.

In combination with some embodiments of the first aspect, in some embodiments, the parameter information includes at least one of the following: identification information of the AI model, storage space information occupied by the AI model, or computational load information of the AI model.

In the above embodiments, by transmitting the parameter information of the AI model, it is determined whether the UE can store the AI model, thereby implementing a negotiation mechanism for the AI model.

In combination with some embodiments of the first aspect, in some embodiments, the AI model transmission response carries AI capability information of the UE, wherein the AI capability information includes: capability information of the UE to run the AI model, and/or capability information of the UE to store the AI model.

In the above embodiments, the AI capability information of the UE carried in the transmission response is used by the first network device to determine whether to transmit the AI model to the UE.

In combination with some embodiments of the first aspect, in some embodiments, the AI capability information includes capability information of the UE before receiving the AI model, or capability information of the UE after receiving the AI model.

In the above embodiments, the UE may carry capability information after receiving the AI model in the AI model transmission response, which is used by the first network device to determine whether to initiate related operations subsequently. The UE may also include capability information before receiving the AI model in the AI model transmission response, which is used by the first network device to determine whether to transmit the AI model to the UE.

In combination with some embodiments of the first aspect, in some embodiments, the first network device includes a gNB, the AI model transmission request and/or AI model transmission response includes at least one of Radio Resource Control (RRC) signaling, MAC Control Element (MAC CE) signaling, or physical layer signaling;
the first network device includes a Location Management Function (LMF), the AI model transmission request and/or AI model transmission response includes LTE Positioning Protocol (LPP) signaling;
the first network device includes Operation, Administration and Maintenance (OAM), the AI model transmission request is sent to the gNB via an MnS Consumer and sent to the UE via the gNB; the AI model transmission response is forwarded to the OAM via the GNB.

In the above embodiments, when the first network device is a gNB, the AI model transmission request and/or AI model transmission response can be at least one of Radio Resource Control (RRC) signaling, MAC Control Element (MAC CE) signaling, or physical layer signaling. When the information is RRC signaling, it can be existing RRC signaling (e.g., RRC Reconfiguration) or newly added RRC signaling (e.g., AI Model Transfer Response).

When the first network device is a Location Management Function (LMF) network element or entity, the AI model transmission request and/or AI model transmission response are LTE Positioning Protocol (LPP) signaling, such as existing LPP signaling (e.g., Provide Location Information signaling) or new LPP signaling (e.g., AI Model Transfer Response signaling).

When the first network device is an Operation, Administration and Maintenance (OAM) network element or entity, the AI model transmission request is sent by the MnS Consumer to the gNB, and then sent by the gNB to the UE; for example, via RRC signaling. The MnS Consumer can directly send the signaling to the gNB, or can also forward it to the gNB through Unified Data Management (UDM) and Access and Mobility Management Function (AMF) network element or entity; the AI model transmission response is forwarded by the UE to the OAM via the gNB.

In combination with some embodiments of the first aspect, in some embodiments, the AI model transmission response includes at least one of the following:
first identification information, identifying whether the UE rejects or accepts the AI model transmission request;
second identification information, identifying a reason why the UE rejects the AI model transmission request.

In the above embodiments, the first identification information indicates whether the UE accepts the AI model transmission request, and the second identification information identifies the reason why the UE rejects the AI model transmission request, thus improving the AI model negotiation mechanism.

In combination with some embodiments of the first aspect, in some embodiments, the method further includes:
receiving capability change information sent by the UE, wherein the capability change information includes capability information after AI capability of the UE changes upon receiving the AI model transmitted by another network device.

In the above embodiments, after the first network device 101 receives the capability change information sent by the UE, it can subsequently determine whether to transmit the AI model to the UE, or request the UE to activate/switch/deactivate the AI model, etc., based on the changed capability information.

In combination with some embodiments of the first aspect, in some embodiments, the first network device includes a gNB, the capability change information is carried in at least one of RRC signaling, MAC CE signaling, or physical layer signaling;
the first network device includes an LMF, the capability change information is carried in LPP signaling;
the first network device includes OAM, the AI model transmission request is sent to the gNB via an MnS Consumer and sent to the UE via the gNB; the AI model transmission response is forwarded to the OAM via the GNB.

In the above embodiments, when the first network device is a gNB, the capability change information can be at least one of Radio Resource Control (RRC) signaling, MAC Control Element (MAC CE) signaling, or physical layer signaling. When the information is RRC signaling, it can be existing RRC signaling (e.g., UE Assistance Information) or newly added RRC signaling (e.g., AI Model Capability). For example, when UE Assistance Information is used to transmit the changed AI capability, if the change in the AI capability of UE is caused by the gNB transmitting an AI model to the UE or by the gNB requesting the UE to activate/switch/deactivate an AI model, the UE does not need to send UEAssistanceInformation to notify the gNB. When the cell handover occurs, the source gNB may send the AI capability change information of the UE to the target gNB.

When the first network device is a Location Management Function (LMF) network element or entity, the capability change information is LTE Positioning Protocol (LPP) signaling, such as existing LPP signaling (e.g., Provide Capabilities signaling) or new LPP signaling (e.g., AI Model Capability signaling).

When the first network device is an Operation, Administration, and Maintenance (OAM) network element or entity, this information is sent by the UE to the gNB, for example, via RRC signaling. The gNB then forwards it to the network management element in the OAM corresponding to the AI.

In combination with some embodiments of the first aspect, in some embodiments, capability change information sent by the UE is received, and the capability change information is forwarded to a second network device, the capability change information includes capability information after AI capability of the UE changes.

In the above embodiments, after receiving the capability change information sent by the UE, the first network device forwards the capability change information to the second network device, so that the second network device can determine whether to transmit the AI model to the UE, or request the UE to activate/switch/deactivate the AI model, etc., based on the changed capability information.

In combination with some embodiments of the first aspect, in some embodiments, forwarding the capability change information to the second network device includes at least one of the following:
the first network device including a gNB, sending the capability change information to the second network device via an NRPPa protocol;
the first network device including an LMF, sending the capability change information to the second network device via the NRPPa protocol;
the first network device including an MN, sending the capability change information to SN, LMF, and/or OAM.

In the above embodiments, when the first network device is a gNB, the capability change information is sent to the second network device via the NRPPa (NR Positioning Protocol A) protocol. When the first network device is an LMF network element or entity, the capability change information is sent to the second network device via the NRPPa protocol. The second network device is, for example, an LMF, or a network management network element in OAM corresponding to the AI.

When the first network device includes an MN, the capability change information is sent to the SN, and the SN forwards the capability change information to the second network device. For example, the UE can send capability change information to the MN, and the MN can then send the AI-related capability of the UE to the SN, the MN then sends it to the LMF via the NRPPa protocol, and forwards it to the network management element corresponding to the AI in the OAM.

In combination with some embodiments of the first aspect, in some embodiments, capability change information sent by the UE forwarded by a third network device is received, wherein the capability change information includes capability information after AI capability of the UE changes.

In the above embodiments, the first network device, upon receiving the capability change information sent by the UE forwarded by the third network device, can determine whether to transmit the AI model to the UE, or request the UE to activate/switch/deactivate the AI model, etc., based on the changed capability information.

In combination with some embodiments of the first aspect, in some embodiments, receiving capability change information of the UE forwarded by a third network device includes at least one of the following:
the third network device including a gNB, receiving the capability change information sent by the third network device via an NRPPa protocol;
the third network device including an LMF, receiving the capability change information sent by the third network device via the NRPPa protocol;
the third network device including an MN, receiving the capability change information forwarded by the third network device.

In the above embodiments, when the third network device is a gNB, it sends the capability change information to the first network device via the NRPPa (NR Positioning Protocol A) protocol, and the first network device receives the information via the NRPPa protocol. When the third network device is an LMF network element or entity, it sends the capability change information to the first network device via the NRPPa protocol, and the first network device receives the information via the NRPPa protocol. The first network device is, for example, an LMF, or a network management network element in OAM corresponding to AI.

When the third network device includes an MN, it sends the capability change information to the SN, and the SN forwards the capability change information to the first network device, and the first network device receives the information via forwarding by the SN.

In combination with some embodiments of the first aspect, in some embodiments, after successfully running or transmitting the AI model, AI capability information of the UE after the AI model is successfully run or transmitted is sent to a fourth network device.

In the above embodiments, after the first network device runs or transmits the AI model, the AI capability information of the UE after the successful running or transmission of the AI model is sent to a fourth network device other than the first network device; that is, the capability change information of the UE after running or transmitting the AI model is sent to other network devices, so that other network devices can learn about the capability change of the UE.

In a second aspect, the embodiments of this disclosure propose an AI model processing method applied to a user equipment (UE), the method includes:
receiving an AI model transmission request sent by a first network device, wherein the AI model transmission request includes parameter information of the AI model; and
feeding back an AI model transmission response to the first network device.

In combination with some embodiments of the second aspect, in some embodiments, the AI model transmission response carries AI capability information of the UE, wherein the AI capability information includes: capability information of the UE to run the AI model, and/or capability information of the UE to store the AI model.

In combination with some embodiments of the second aspect, in some embodiments; the parameter information includes at least one of the following:
identification information of the AI model, storage space information occupied by the AI model, or computational load information of the AI model.

In combination with some embodiments of the second aspect, in some embodiments, the first network device includes a gNB, the AI model transmission request and/or AI model transmission response includes at least one of RRC signaling, MAC CE signaling, or physical layer signaling;
the first network device includes an LMF, the AI model transmission request and/or AI model transmission response includes LPP signaling;
the first network device includes OAM, the AI model transmission request is sent to the gNB via an MnS Consumer and sent to the UE via the gNB; the AI model transmission response is forwarded to the OAM via the gNB.

In combination with some embodiments of the second aspect, in some embodiments, the AI model transmission response includes at least one of the following:
first identification information, identifying whether the UE rejects or accepts the AI model transmission request;
second identification information, identifying a reason why the UE rejects the AI model transmission request.

In combination with some embodiments of the second aspect, in some embodiments, the AI capability information includes capability information of the UE before receiving the AI model, or capability information of the UE after receiving the AI model.

In combination with some embodiments of the second aspect, in some embodiments, the method further includes:
sending capability change information of the UE to the first network device, wherein the capability change information includes capability information after AI capability of the UE changes upon receiving the AI model transmitted by another network device.

In combination with some embodiments of the second aspect, in some embodiments,
the first network device includes a gNB, the capability change information is carried in at least one of RRC signaling, MAC CE signaling, or physical layer signaling;
the first network device includes an LMF, the capability change information is carried in LPP signaling;
the first network device or the third network device includes an OAM, the AI model transmission request is sent to the gNB via an MnS Consumer, and sent to the UE via the gNB; the AI model transmission response is forwarded to the OAM via the gNB.

In combination with some embodiments of the second aspect, in some embodiments, capability change information of the UE is sent to a third network device, indicating the third network device to forward the capability change information to a second network device, wherein the capability change information includes capability information after AI capability of the UE changes.

In combination with some embodiments of the second aspect, in some embodiments, sending the capability change information of the UE to the third network device includes:
the third network device including a gNB, the capability change information carried in at least one of RRC signaling, MAC CE signaling, or physical layer signaling;
the third network device including an LMF, the capability change information carried in LPP signaling;
the third network device including OAM, the AI model transmission request is sent to the gNB via an MnS Consumer and sent to the UE via the gNB; the AI model transmission response is forwarded to the OAM via the gNB.

In combination with some embodiments of the second aspect, in some embodiments, the AI capability information includes: capability information of the UE to run the AI model, and/or capability information of the UE to store the AI model.

In a third aspect, embodiments of this disclosure also provide an AI model processing method applied to a first network device, the method includes:
receiving capability change information sent by a user equipment (UE), wherein the capability change information includes capability information after AI capability of the UE changes upon receiving the AI model transmitted by another network device.

In combination with some embodiments of the third aspect, in some embodiments, the AI capability information includes: capability information of the UE to run the AI model, and/or capability information of the UE to store the AI model.

In combination with some embodiments of the third aspect, in some embodiments, the first network device includes a gNB, the capability change information is carried in at least one of RRC signaling, MAC CE signaling, or physical layer signaling;
the first network device includes an LMF, the capability change information is carried in LPP signaling;
the first network device includes OAM, the AI model transmission request is sent to the gNB via an MnS Consumer, and sent to the UE via the gNB; the AI model transmission response is forwarded to the OAM via the gNB.

In a fourth aspect, embodiments of this disclosure also provide an AI model processing method applied to a user equipment (UE), including:
sending capability change information of the UE to a first network device, after receiving an AI model transmitted by another network device, wherein the capability change information includes capability information after AI capability of the UE changes.

In combination with some embodiments of the fourth aspect, in some embodiments, the AI capability information includes: capability information of the UE to run the AI model, and/or capability information of the UE to store the AI model.

In combination with some embodiments of the fourth aspect, in some embodiments, the first network device includes a gNB, the capability change information is carried in at least one of RRC signaling, MAC CE signaling, or physical layer signaling;
the first network device includes an LMF, the capability change information is carried in LPP signaling;
the first network device or a third network device includes OAM, the AI model transmission request is sent to the gNB via an MnS Consumer, and sent to the UE via the gNB; the AI model transmission response is forwarded to the OAM via the gNB.

In a fifth aspect, embodiments of this disclosure also provide an AI model processing method applied to a first network device, including:
receiving capability change information of a user equipment (UE), and forwarding the capability change information to a second network device, wherein the capability change information includes capability information after AI capability of the UE changes.

In combination with some embodiments of the fifth aspect, in some embodiments, forwarding the capability change information to the second network device includes at least one of the following:
the first network device including a gNB, sending the capability change information to the second network device via an NRPPa protocol;
the first network device including an LMF, sending the capability change information to the second network device via the NRPPa protocol;
the first network device including an MN, sending the capability change information to SN, LMF, and/or OAM.

In combination with some embodiments of the fifth aspect, in some embodiments, the AI capability information includes: capability information of the UE to run the AI model, and/or capability information of the UE to store the AI model.

In a sixth aspect, embodiments of this disclosure also provide an AI model processing method applied to a user equipment (UE), including:
sending capability change information of the UE to a third network device, indicating the third network device to forward the capability change information to a second network device, wherein the capability change information includes capability information after AI capability of the UE changes.

In combination with some embodiments of the sixth aspect, in some embodiments, sending the capability change information of the UE to the third network device includes:
the third network device including a gNB, the capability change information carried in at least one of RRC signaling, MAC CE signaling, or physical layer signaling;
the third network device including an LMF, the capability change information carried in LPP signaling;
the third network device including OAM, the AI model transmission request is sent to the gNB via an MnS Consumer and sent to the UE via the gNB; the AI model transmission response is forwarded to the OAM via the gNB.

In combination with some embodiments of the sixth aspect, in some embodiments, the AI capability information includes: capability information of the UE to run the AI model, and/or capability information of the UE to store the AI model.

In a seventh aspect, embodiments of this disclosure also provide a network device, which is a first network device and includes at least one of a request sending module, a response receiving module, and a transmission determining module; wherein the network device is configured to execute optional implementations of the first, third, and fifth aspects.

In an eighth aspect, embodiments of this disclosure also provide a user equipment, including: a request receiving module and a response sending module; wherein the user equipment is configured to execute optional implementations of the second, fourth, and sixth aspects.

In a ninth aspect, embodiments of this disclosure also provide a network device, which is a first network device and includes:
one or more processors;
wherein the network device is configured to execute optional implementations of the first, third, and fifth aspects.

In a tenth aspect, embodiments of this disclosure also provide a user equipment, including:
one or more processors;
wherein the user equipment is configured to execute optional implementations of the second, fourth, and sixth aspects.

In a eleventh aspect, embodiments of this disclosure also provide a communication system, including a network device and a user equipment; wherein the network device is configured to perform optional implementations as described in the first, third, and fifth aspects, and the user equipment is configured to perform optional implementations as described in the second, fourth, and sixth aspects.

In a twelfth aspect, embodiments of this disclosure also provide a storage medium storing instructions that, when executed on a communication device, cause the communication device to perform the optional implementations as described in the first to sixth aspects.

In a thirteenth aspect, embodiments of this disclosure provide a program product that, when executed by a communication device, causes the communication device to perform the method described in the optional implementations of the first to sixth aspects.

In a fourteenth aspect, embodiments of this disclosure provide a computer program that, when executed on a computer, causes the computer to perform the method described in the optional implementations of the first to sixth aspects.

In a fifteenth aspect, embodiments of this disclosure provide a chip or chip system. The chip or chip system includes processing circuitry configured to perform the method described in the optional implementations of the first to sixth aspects.

It may be understood that the aforementioned network devices, user equipment, communication systems, storage media, program products, computer programs, chips, or chip systems are all used to execute the methods proposed in the embodiments of this disclosure. Therefore, the achieved beneficial effects can be referred to the beneficial effects in the corresponding methods, and will not be repeated here.

The embodiments of this disclosure propose an AI model processing method, a network device, a user equipment, and a communication system. In some embodiments, the terms AI model processing method, signal transmission method, and wireless frame transmission method can be interchanged, the terms information processing system and communication system can be interchanged.

The embodiments disclosed herein are not exhaustive, but merely illustrative of some embodiments, and are not intended to limit the scope of protection of this disclosure. Unless contradictory, each step in a particular embodiment can be implemented as an independent embodiment, and the steps can be arbitrarily combined. For example, a solution after removing some steps in a particular embodiment can also be implemented as an independent embodiment, and the order of the steps in a particular embodiment can be arbitrarily interchanged. Furthermore, the optional implementation methods in a particular embodiment can be arbitrarily combined; moreover, the embodiments can be arbitrarily combined. For example, some or all steps of different embodiments can be arbitrarily combined, and a particular embodiment can be arbitrarily combined with optional implementations of other embodiments.

In each embodiment of this disclosure, unless otherwise specified or logically conflicting, the terminology and/or descriptions between the embodiments are consistent and can be mutually referenced. Technical features in different embodiments can be combined to form new embodiments based on their inherent logical relationships.

The terminology used in the embodiments of this disclosure is only for the purpose of describing specific embodiments and is not intended to limit this disclosure.

In embodiments of this disclosure, “a plurality of” refers to two or more.

In some embodiments, terms such as “at least one of”, “one or more”, “a plurality of” and “multiple” can be used interchangeably.

In some embodiments, “at least one of A and B”, “A and/or B”, “A in one situation, B in another situation”, “in response to one situation A, in response to another situation B”, etc., may include the following technical solutions depending on the situation: in some embodiments, A (A executed independently of B); in some embodiments, B (B executed independently of A); in some embodiments, selective execution from A and B (A and B are selectively executed); in some embodiments, A and B (both A and B are executed). The same applies when there are more branches such as A, B, C, etc.

In some embodiments, “A or B” etc., may include the following technical solutions depending on the situation: in some embodiments, A (A executed independently of B); in some embodiments, B (B executed independently of A); in some embodiments, selective execution from A and B (A and B are selectively executed). The same applies when there are more branches such as A, B, C, etc.

The prefixes such as “first”, “second” or the like in the embodiments of this disclosure are merely for distinguishing different described objects and do not constitute restrictions on the position, order, priority, number, or content of the described objects. For the description of the described objects, please refer to the description in the claims or the context of the embodiments, and the use of prefixes should not constitute unnecessary restrictions. For example, if the described object is “field”, then the ordinal numbers preceding “field” in “first field” and “second field” do not restrict the position or order of the “field”, “first” and “second” do not restrict whether the “fields” they modify are in the same message, nor do they restrict the order of “first field” and “second field.” As another example, if the described object is “level”, then the ordinal numbers preceding “level” in “first level” and “second level” do not restrict the priority between “levels”. For another example, the number of described objects is not limited by ordinal numbers, which can be one or more. For example, for “first apparatus”, the number of “apparatus” can be one or more. Furthermore, objects modified by different prefixes can be the same or different. For instance, if the described object is “apparatus”, then “first apparatus” and “second apparatus” can be the same apparatus or different apparatuses, and their types can be the same or different. Similarly, if the described object is “information”, then “first information” and “second information” can be the same information or different information, and their content can be the same or different.

In some embodiments, “including A”, “containing A”, “for indicating A” and “carrying A” can be interpreted as directly carrying A or indirectly indicating A.

In some embodiments, terms such as “in response to . . . ” , “in response to determining . . . ”, “in a case that . . . ” , “at the time of . . . ” , “when . . . ” , “if . . . ” , “assuming that . . . ” or the like can be used interchangeably.

In some embodiments, terms such as “greater than”, “greater than or equal to”, “not less than”, “more than”, “more than or equal to”, “not smaller than”, “higher”, “higher than or equal to”, “not lower than”, “above” or the like can be used interchangeably, and terms such as “smaller than”, “smaller than or equal to”, “not greater than”, “less than”, “less than or equal to”, “no more than”, “lower than”, “lower than or equal to”, “not higher than”, “below” or the like can be used interchangeably.

In some embodiments, apparatus and devices or the like can be interpreted as physical or virtual, and its name is not limited to the names described in the embodiments, in some cases, they may be understood as “equipment”, “device”, “circuit”, “network element”, “node”, “function”, “unit”, “section”, “system”, “network”, “chip”, “chip system”, “entity”, “subject” etc.

In some embodiments, “network” can be interpreted as apparatuses included in the network, such as an access network device, a core network device, etc.

In some embodiments, “access network device (AN device)” may also be called “radio access network device (RAN device)”, “base station (BS)”, “radio base station”, “fixed station”, in some embodiments, also be understood as “node”, “access point”, “transmission point (TP)”, “reception point (RP)”, “transmission/or reception point (TRP)”, “panel”, “antenna panel”, “antenna array”, “cell”, “macro cell”, “small cell”, “femto cell”, “pico cell”, “sector”, “cell group”, “serving cell”, “carrier”, “component carrier”, “bandwidth part (BWP)”, etc.

In some embodiments, “terminal” or “terminal device” may be called “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, etc.

In some embodiments, the acquisition of data, information or the like may comply with the laws and regulations of the country where the acquisition takes place.

In some embodiments, data, information, etc., may be acquired after obtaining the user consent.

Furthermore, each element, each row, or each column in the tables of embodiments of this disclosure can be implemented as an independent embodiment, and any combination of any element, any row, or any column can also be implemented as an independent embodiment.

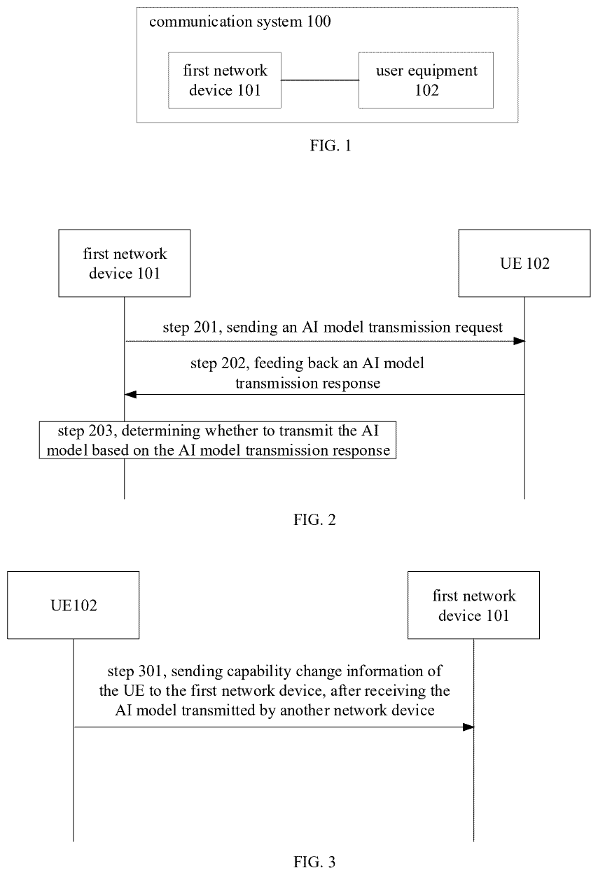

FIG. 1 is a schematic diagram of a communication system architecture according to an embodiment of this disclosure.

As shown in FIG. 1, the communication system 100 includes a first network device 101 and a user equipment (UE) 102.

In some embodiments, the UE 102 includes, for example, at least one of the following: a mobile phone, a wearable device, Internet of Things device, a car with communication capabilities, a smart car, a Pad, a computer with wireless transceiver capabilities, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, and a wireless terminal device in smart home, but is not limited thereto.

In some embodiments, the first network device 101 may include at least one of an access network device and a core network device.

In some embodiments, the core network device may be a single device including one or more network elements, or it may be multiple devices or a group of devices, each including all or part of the aforementioned one or more network elements. The network elements may be virtual or physical. The core network includes, for example, at least one of the Evolved Packet Core (EPC), 5G Core Network (5GCN), and Next Generation Core (NGC).

It can be understood that, the communication system described in embodiments of this disclosure is for the purpose of more clearly illustrating the technical solutions of embodiments of this disclosure and does not constitute a limitation on the technical solutions provided in embodiments of this disclosure. Those skilled in the art will recognize that with the evolution of system architectures and the emergence of new service scenarios, the technical solutions provided in embodiments of this disclosure are also applicable to similar technical problems.

The following embodiments of this disclosure can be applied to the communication system 100 or some of its entities shown in FIG. 1, but not limited thereto. The entities shown in FIG. 1 are illustrative, the communication system may include all or some of the entities in FIG. 1, and may also include other entities not shown in FIG. 1. The number and form of each entity are arbitrary, each entity can be either physical or virtual, the connection relationship between the entities is illustrative; the entities may be unconnected or connected, and the connection can be in any manner, including direct or indirect connections, wired or wireless connections.

The embodiments disclosed herein can be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), Future Radio Access (FRA), New-Radio Access Technology (RAT), New Radio (NR), New radio access (NX), Future generation radio access (FX), Global System for Mobile communications (GSM, a registered trademark), CDMA2000, Ultra Mobile Broadband (UMB), IEEE 802.11 (Wi-Fi, a registered trademark), IEEE 802.16 (WiMAX, a registered trademark), and IEEE 802.20, Ultra-Wideband (UWB), Bluetooth (a registered trademark), Public Land Mobile Network (PLMN) networks, Device-to-Device (D2D) systems, Machine-to-Machine (M2M) systems, Internet of Things (IoT) systems, Vehicle-to-Everything (V2X), systems utilizing other resource determining methods, and next-generation systems extended based thereon, etc. Furthermore, a combination of multiple systems (e.g., a combination of LTE or LTE-A and 5G, etc.) may also be applied.

FIG. 2 is an interactive schematic diagram of an AI model processing method according to an embodiment of this disclosure. As shown in FIG. 2, the method includes:

step 201, a first network device 101 sends an AI model transmission request to a user equipment UE 102, wherein the AI model transmission request includes parameter information of the AI model;

In 5G systems, AI models can be used for prediction and inference to improve system performance, for example in scenarios such as Channel State Information (CSI) feedback enhancement, beam management, and positioning accuracy enhancement. It is understood that in this embodiment of the disclosure, an AI model refers to a mathematical model that uses methods from fields such as mathematics, statistics, computer science, and machine learning to analyze, process, predict, and optimize data.

When the AI model is trained on the network side or an Over The Top (OTT) server, and AI inference is run on the UE side, the network side needs to transmit the AI model to the UE. Taking use cases of CSI feedback enhancement and beam management as examples, gNB, Operation, Administration and Maintenance (OAM), OTT server or Core Network (CN) network elements can transmit AI models to the UE. Taking a use case of positioning accuracy enhancement as an example, OTT server, Location Management Function (LMF), OAM or CN network elements can transmit AI models to the UE.

For the same AI use case, since different AI models may have different applicable conditions, the UE may need to store a plurality of models for the same AI use case, thus using different AI models depending on different situations. The UE may also use a plurality of AI use cases, therefore requiring models for a plurality of AI use cases.

Therefore, typically, the UE needs to store a plurality of models for a plurality of AI use cases, and the UE needs a certain amount of storage space to store a plurality of AI models. In this embodiment of the disclosure, before transmitting the AI model to the UE, the first network device first sends an AI model transmission request to the UE, carrying the parameter information of the AI model in the AI model transmission request, such that the UE determines whether it can receive the AI model based on the parameter information, and only transmits the AI model to the UE when the UE indicates that the UE can receive the AI model.

Optionally, the parameter information of the AI model may include an ID of the AI model, the amount of memory required to run the model, the amount of storage required for the model, and the computational load required for one inference.

Step 202, UE 102 feeds back an AI model transmission response to the first network device 101.

After receiving the AI model transmission request, the UE may fall into two situations: the first situation, the UE determines whether it can receive the AI model based on the parameter information carried in the AI model transmission request, and feeds back an AI model transmission response to the first network device; the second situation, the UE sends its AI capability information to the first network device, and then the first network device decides whether to transmit the AI model to the UE by itself.

Specifically, in the first situation, taking the parameter information including the memory size required to run the model as an example, when the UE runs an AI model, it requires a certain amount of RAM. If the current remaining RAM of UE is insufficient to cover the memory size occupied by the AI model to be transmitted by the first network device, the UE cannot run the AI model. Therefore, the UE feeds back an AI model transmission response to the first network device, identifying rejection of receiving the AI model in the AI model transmission response. Conversely, if the current remaining RAM of the UE is sufficient to cover the memory size occupied by the AI model to be transmitted by the first network device, the UE can run the AI model, feed back an AI model transmission response to the first network device, identifying receiving of the AI model in the AI model transmission response. The same logic applies when the parameter information includes the storage size required for the model, and will not be elaborated further here.

For example, the parameter information includes the computational load (or amount of calculation) required to perform one inference. The computational load is measured in floating-point operations (FLOPs), which refer to the total number of floating-point operations required for one inference. For example, 1 GFLOPs means that the AI model requires 109 floating-point operations to perform one inference. The computing speed of AI hardware can be measured in floating-point operations per second (FLOPS; note that the “S” in FLOPS is uppercase, different from FLOPs). The UE calculates the time required for the AI hardware to perform one inference based on its own AI hardware computing speed and the computational load of the AI model. For example, if an AI hardware of the UE with 10 GFLOPS runs an AI model with the computational load of 1 GFLOPs, the time required for one AI inference is 1 GFLOPs/10 GFLOPS=0.1 seconds. Based on this time, it determines whether the runtime latency requirements of the model are met, and whether the UE can run the AI model, feeding back an AI model transmission response to the first network device.

In the second situation, the UE sends its AI capability information to the first network device, and the first network device determines whether to transmit the AI model to the UE based on the AI capability information. The determination process is similar to the first situation and will not be repeated here.

Step 203, the first network device 101 determines whether to transmit the AI model based on the AI model transmission response.

The first network device 101 determines whether to transmit the AI model based on the AI model transmission response fed back by the UE.

In embodiments of this disclosure, a first network device sends an AI model transmission request to a user equipment (UE), the AI model transmission request includes parameter information of the AI model; receives an AI model transmission response fed back by the UE; and determines whether to transmit the AI model based on the AI model transmission response. The embodiments of this disclosure provide a coordination mechanism for AI model transmission and operation between the UE and the network device. Under this mechanism, the network device can learn about the dynamically changing capability of the UE regarding the storage and operation of the AI model before transmitting or running the AI model, thereby avoiding the problem of being unable to store or run the AI model.

In some embodiments, the AI model transmission response carries AI capability information of the UE, wherein the AI capability information includes: capability information of the UE to run the AI model, and/or capability information of the UE to store the AI model.

In the embodiment of this disclosure, the AI model transmission response may only carry capability information of the UE to store the AI model, for the first network device to determine whether to transmit the AI model to the UE.

Furthermore, the AI capability information may simultaneously include capability information of the UE to run the AI model and capability information of the UE to store the AI model; for example, when transmitting the AI model to the UE, the first network device may simultaneously determine the capability information of the UE to run the AI model; for example, if the UE can only store the AI model but cannot run the AI model, the first network device may not transmit the AI model to the UE, to avoid it cannot be run after transmission.

Alternatively, the AI model transmission response may only carry capability information of the UE to run the AI model; for example, if the UE has already stored the AI model locally, the first network device determines whether to enable the AI model based on whether the UE can run the AI model.

In some embodiments, the AI capability information includes capability information of the UE before receiving the AI model, or capability information of the UE after receiving the AI model.

In the first situation, the UE can carry capability information after receiving the AI model in the AI model transmission response, for the first network device to determine whether to initiate related operations subsequently; that is, when the UE accepts or rejects the AI model transmission request, the terminal capability of the UE regarding AI can be either the terminal capability before accepting the current AI transmission request or the terminal capability after accepting the current AI transmission request (e.g., the remaining storage space after the AI model occupies the storage space after the current AI transmission is successful).

In the second situation, the UE can carry its AI capability information in the AI model transmission response. This AI capability information includes capability information of the UE before receiving the AI model, and the first network device determines whether to transmit the AI model to the UE based on the capability information of the UE before receiving the AI model.

In some embodiments, the first network device includes a gNB, the AI model transmission request and/or AI model transmission response includes at least one of Radio Resource Control (RRC) signaling, MAC Control Element (MAC CE) signaling, or physical layer signaling; the first network device includes a Location Management Function (LMF), the AI model transmission request and/or AI model transmission response includes LTE Positioning Protocol (LPP) signaling;
the first network device includes Operation, Administration and Maintenance (OAM), the AI model transmission request is sent to the gNB via an MnS Consumer and sent to the UE via the gNB; the AI model transmission response is forwarded to the OAM via the gNB.

When the first network device is a gNB, the AI model transmission request can be at least one of Radio Resource Control (RRC) signaling, MAC Control Element (MAC CE) signaling, or physical layer signaling. For example, the AI model transmission request is RRC signaling, which can be existing RRC signaling (e.g., RRCReconfiguration signaling) or newly added RRC signaling (e.g., AIModelTransfer signaling).

When the first network device is a gNB, the AI model transmission response can also be at least one of RRC signaling, MAC CE, or physical layer signaling. For example, the AI model transmission response is RRC signaling, which can be existing RRC signaling (e.g., RRCReconfigurationComplete signaling), or newly added RRC signaling (e.g., AIModelTransferResponse signaling).

When the first network device is a Location Management Function (LMF) network element or entity, the AI model transmission request is LTE Positioning Protocol (LPP) signaling, such as existing LPP signaling (e.g., ProvideAssistanceData signaling or RequestLocationInformation signaling) or new LPP signaling (e.g., AIModelTransfer).

When the first network device is an LMF network element or entity, the AI model transmission response is LPP signaling, such as existing LPP signaling (e.g., ProvideLocationInformation signaling), or new LPP signaling (e.g., AIModelTransferResponse signaling).

When the first network device is an Operation, Administration and Maintenance (OAM) network element or entity, the AI model transmission request is sent by the MnS Consumer to the gNB, and then by the gNB to the UE; for example, via RRC signaling. The MnS Consumer can directly send the signaling to the gNB, or can also forward it to the gNB through Unified Data Management (UDM) and Access and Mobility Management Function (AMF) network element or entity.

When the first network device is an OAM network element or entity, the AI model transmission response is forwarded by the UE to the OAM via the gNB; that is, the information is sent by the UE to the gNB, for example, via RRC signaling. Then, the gNB forwards it to the network management network element corresponding to AI in the OAM.

In some embodiments, the AI model transmission response includes at least one of the following:
first identification information, identifying whether the UE rejects or accepts the AI model transmission request;
second identification information, identifying a reason why the UE rejects the AI model transmission request.
The first identification information can identify that the UE rejects the AI model transmission request, or accepts the AI model transmission request; for example, the first identification information is set as “1”, to indicate accepting the AI model transmission request; the first identification information is set as “0”, to indicate rejecting the AI model transmission request.

The second identification information identifies the reason why the UE rejects the AI model transmission request; for example, the first identification information is set as “0”, to indicate that the UE's AI model storage space cannot accommodate the model to be transmitted; the first identification information is set as “1”, to indicate that the UE's AI hardware capability cannot meet the computational load requirements of the AI model.

In some embodiments, as shown in FIG. 3, the method further includes:
step 301, the first network device 101 receives capability change information sent by the UE, wherein the capability change information includes capability information after AI capability of the UE changes upon receiving the AI model transmitted by another network device.

When the AI-related capability (AI capability) of the UE changes, the UE sends the change information of the AI capability to the first network device that may transmit the AI model to the UE. The capability change information is, for example, the remaining AI model storage space, the remaining memory size for running the AI model, etc.

Optionally, this change in AI capability can be caused by other network devices (excluding the first network device) transmitting an AI model to the UE, or by other network devices requesting the UE to activate/switch/deactivate the AI model, or by a change in the UE's internal state (e.g., a change in available memory). In this case, the UE may not send capability change information to the network device that caused the change. For example, if the UE's AI capability changes due to receiving an AI model from the gNB, the UE may not notify the gNB of this change. For example, after receiving the AI model from the gNB, the UE may send the changed AI capability to the LMF and other network devices that might transmit the AI model to the UE; or, after receiving the AI model from the LMF, the UE may send the changed AI capability to the gNB and other network devices that might transmit the AI model to the UE.

When a UE is configured with dual connectivity and both the Master Node (MN) and the Secondary Node (SN) might transmit the AI model to the UE, after the UE receives the AI model from the MN, the UE sends the changed AI capability to the SN, the LMF, and other network devices that might transmit the AI model to the UE. After the UE receives the AI model from the SN, the UE sends the changed AI capability to the MN, the LMF, and other network devices that may transmit the AI model to the UE. After the UE receives the AI model from the LMF, the UE sends the changed AI capability to the MN, the SN, and the first network device that might transmit the AI model to the UE.

After receiving the capability change information sent by the UE, the first network device 101 can subsequently determine whether to transmit the AI model to the UE, or request the UE to activate/switch/deactivate the AI model, etc., based on the changed capability information.

In some embodiments, the first network device includes a gNB, the capability change information is carried in at least one of RRC signaling, MAC CE signaling, or physical layer signaling;
the first network device includes an LMF, the capability change information is carried in LPP signaling;
the first network device includes OAM, the capability change information is carried in RRC signaling.

When the first network device is a gNB, the capability change information can be at least one of Radio Resource Control (RRC) signaling, MAC Control Element (MAC CE), or physical layer signaling. When the information is RRC signaling, it can be existing RRC signaling (e.g., UEAssistanceInformation signaling) or newly added RRC signaling (e.g., AIModelCapabilitysignaling). For example, when UEAssistanceInformation signaling is used to transmit the changed AI capability, if the change in the AI capability of UE is caused by the gNB transmitting an AI model to the UE or by the gNB requesting the UE to activate/switch/deactivate an AI model, the UE does not need to send the UEAssistanceInformation signaling to notify the gNB. When the cell handover occurs, the source gNB may send the AI capability change information of the UE to the target gNB.

When the first network device is a Location Management Function (LMF) network element or entity, the capability change information is LTE Positioning Protocol (LPP) signaling, such as existing LPP signaling (e.g., ProvideCapabilities signaling) or new LPP signaling (e.g., AIModelCapability signaling).

When the first network device is an Operation, Administration, and Maintenance (OAM) network element or entity, this information is sent by the UE to the gNB, for example, via RRC signaling. The gNB then forwards it to the network management element in the OAM (first network device) corresponding to the AI.

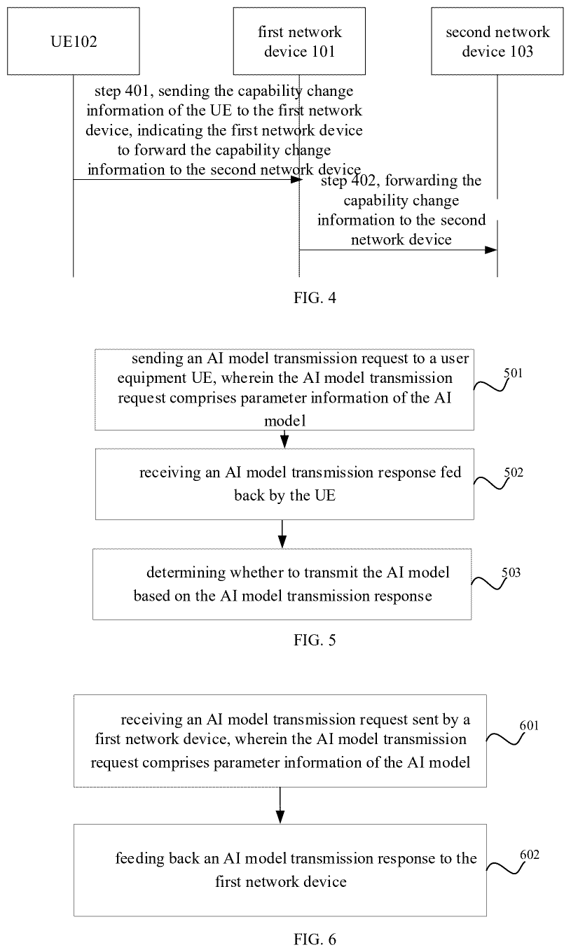

In some embodiments, as shown in FIG. 4, the method further includes: step 401, UE 102 sends the capability change information of the UE to the first network device 101, indicating the first network device 101 to forward the capability change information to the second network device 103.

The first network device 101 can serve as a device for forwarding the capability change information to other network devices. For example, when the AI-related capability of the UE changes, the UE sends the capability change information (e.g., remaining AI model storage space, remaining memory size for running the AI model, etc.) to a specific first network device (e.g., gNB or LMF), which then forwards the capability change information to other second network devices that might transmit the AI model to the UE.

It is understood that after UE 102 sends the capability change information of the UE to the first network device 101, it implicitly indicates the first network device to perform a forwarding operation through the capability change information, rather than explicitly indicating the first network device to perform a forwarding operation by carrying an indicator bit or other manners.

Step 402, the first network device 101 receives capability change information sent by the UE 102 and forwards the capability change information to the second network device 103. The capability change information includes capability information after AI capability of the UE 102 changes.

The first network device 101 forwards the capability change information to the second network device 103, to facilitate the second network device 103 to determine whether to transmit an AI model to the UE, or to request the UE to activate/switch/deactivate the AI model, etc., based on the changed capability information.

In some embodiments, forwarding the capability change information to the second network device includes at least one of the following:
the first network device including a gNB, sending the capability change information to the second network device via an NRPPa protocol, the second network device is, for example, an LMF;
the first network device including an LMF, sending the capability change information to the second network device via the NRPPa protocol, the second network device is, for example, a gNB;
the first network device including an MN, sending the capability change information to the second network device, the second network device is, for example, an SN, an LMF, and/or an OAM.

When the first network device is a gNB, the capability change information is sent to the second network device via the NRPPa (NR Positioning Protocol A). When the first network device is an LMF network element or entity, the capability change information is sent to the second network device via the NRPPa protocol. The second network device may be, for example, an LMF or a network management element in OAM corresponding to the AI.

When the first network device includes an MN, the capability change information is sent to the SN, which forwards the capability change information to the second network device. For example, the UE can send the capability change information to the MN, and the MN can then send the AI-related capability of the UE to the SN, LMF, and/or OAM.

In some embodiments, the method further includes:
receiving capability change information sent by the UE forwarded by a third network device, wherein the capability change information includes capability information after AI capability of the UE changes.

The third network device can serve as a device for forwarding capability change information to other network devices. For example, when the AI-related capability of the UE changes, the UE sends capability change information (e.g., remaining AI model storage space, remaining memory size for running the AI model, etc.) to a specific third network device (e.g., a gNB or LMF), then this third network device forwards the capability change information to other network devices that might transmit the AI model to the UE, such as a first network device. The first network device receives the capability change information sent by the UE and forwarded by the third network device.

In some embodiments, receiving capability change information of the UE forwarded by a third network device includes at least one of the following:
the third network device including a gNB, receiving the capability change information sent by the third network device via an NRPPa protocol;
the third network device including an LMF, receiving the capability change information sent by the third network device via the NRPPa protocol;
the third network device including an MN, receiving the capability change information forwarded by the third network device.

When the third network device is a gNB, it sends the capability change information to the first network device via the NRPPa (NR Positioning Protocol A) protocol, and the first network device receives the information via the NRPPa protocol. When the third network device is an LMF network element or entity, the capability change information is sent to the first network device via the NRPPa protocol, and the first network device receives the information via the NRPPa protocol. The first network device may be, for example, an LMF or a network management element in OAM corresponding to the AI.

When the third network device includes an MN, the UE sends the capability change information to the MN, and the MN forwards the capability change information to the first network device, the first network device is, for example, an SN, an LMF, and/or OAM.

In some embodiments, the method further includes:
after successfully running or transmitting the AI model, sending AI capability information of the UE after the AI model is successfully run or transmitted to a fourth network device.

In the embodiment, after the first network device runs or transmits the AI model, the AI capability information of the UE after the successful running or transmission of the AI model is sent to a fourth network device other than the first network device; that is, the capability change information of the UE after running or transmitting the AI model is sent to other network devices, so that other network devices can learn about the capability change of the UE.

In some embodiments, the names of information, etc., are not limited to those described in the embodiments. Terms such as “information”, “message”, “signal”, “signaling”, “report”, “configuration”, “indication”, “instruction”, “command”, “channel”, “parameter”, “domain”, “field”, “symbol”, “codepoint”, “bit”, “data”, “program” and “chip” can be used interchangeably.

In some embodiments, terms such as “moment”, “point in time”, “time”, and “time location” can be used interchangeably. Terms such as “duration”, “segment”, “time window”, “window”, and “time” can be used interchangeably.

In some embodiments, terms such as “wireless access scheme” and “waveform” can be used interchangeably.

In some embodiments, the terms “certain”, “preseted”, “preset”, “set”, “indicated”, “a certain”, “arbitrary” and “first” can be used interchangeably, “certain A”, “predetermined A”, “preset A”, “set A”, “indicated A”, “a certain A”, “arbitrary A” and “first A” can be interpreted as pre-specified A in an agreement, an A obtained through setting, configuration or indication, or a specific A, a certain A, an arbitrary A, or first A, etc., but are not limited to this.

In some embodiments, determination or judgment can be performed using a value (0 or 1) represented by 1 bit, or by a true/false value (Boolean value) represented by true/false, or by numerical comparison (e.g., comparison with a predetermined value), but are not limited to these.

In some embodiments, “not expecting reception” can be interpreted as not receiving on time-domain and/or frequency-domain resources, or as not performing subsequent processing on data, etc., after receiving data, etc. ; “not expecting transmission” can be interpreted as not transmitting, or as transmitting but not expecting a response from the receiver.

The AI model processing method involved in the embodiment of the disclosure may include at least one of the foregoing steps and embodiments. For example, step 201 may be implemented as an independent embodiment, step 301 may be implemented as an independent embodiment, and step 401 may be implemented as an independent embodiment; the combination of steps 201, 202, and 203 may be implemented as an independent embodiment, the combination of steps 401 and 402 may be implemented as an independent embodiment, but are not limited thereto.

In some embodiments, other optional implementations described before or after FIGS. 2 to 4 may be referred to.

FIG. 5 is one of the schematic flowcharts of the AI model processing methods according to an embodiment of this disclosure.

As shown in FIG. 5, the above method can be applied to a first network device 101, and the method includes:
step 501, sending an AI model transmission request to a user equipment (UE), wherein the AI model transmission request includes parameter information of the AI model;
step 502, receiving an AI model transmission response fed back by the UE; and
step 503, determining whether to transmit the AI model based on the AI model transmission response.

Optionally, in this embodiment of the disclosure, the parameter information includes at least one of the following:
identification information of the AI model, storage space information occupied by the AI model, or computational load information of the AI model.

Optionally, in this embodiment of the disclosure, the AI model transmission response carries AI capability information of the UE, wherein the AI capability information includes: capability information of the UE to run the AI model, and/or capability information of the UE to store the AI model.

Optionally, in this embodiment of the disclosure, the AI capability information includes capability information of the UE before receiving the AI model, or capability information of the UE after receiving the AI model.

Optionally, in this embodiment of the disclosure, the first network device includes a gNB, the AI model transmission request and/or AI model transmission response includes at least one of Radio Resource Control (RRC) signaling, MAC Control Element (MAC CE) signaling, or physical layer signaling;
the first network device includes a Location Management Function (LMF), the AI model transmission request and/or AI model transmission response includes LTE Positioning Protocol (LPP) signaling;
the first network device includes Operation, Administration and Maintenance (OAM), the AI model transmission request is sent to the gNB via an MnS Consumer and sent to the UE via the gNB; the AI model transmission response is forwarded to the OAM via the GNB.

Optionally, in this embodiment of the disclosure, the AI model transmission response includes at least one of the following:
first identification information, identifying whether the UE rejects or accepts the AI model transmission request;
second identification information, identifying a reason why the UE rejects the AI model transmission request.

Optionally, in this embodiment of the disclosure, the method further includes:
step 504, receiving capability change information sent by the UE, wherein the capability change information includes capability information after AI capability of the UE changes upon receiving the AI model transmitted by another network device.

Optionally, in this embodiment of the disclosure, the first network device includes a gNB, the capability change information is carried in at least one of RRC signaling, MAC CE signaling, or physical layer signaling;
the first network device includes an LMF, the capability change information is carried in LPP signaling;
the first network device includes OAM, the AI model transmission request is sent to the gNB via an MnS Consumer and sent to the UE via the gNB; the AI model transmission response is forwarded to the OAM via the gNB.

Optionally, in this embodiment of the disclosure, the method further includes: step 505, receiving capability change information sent by the UE, and forwarding the capability change information to a second network device, wherein the capability change information includes capability information after AI capability of the UE changes.

Optionally, in this embodiment of the disclosure, forwarding the capability change information to the second network device includes at least one of the following:
the first network device including a gNB, sending the capability change information to the second network device via an NRPPa protocol;
the first network device including an LMF, sending the capability change information to the second network device via the NRPPa protocol;
the first network device including an MN, sending the capability change information to SN, LMF, and/or OAM.

Optionally, in this embodiment of the disclosure, the method further includes:
step 506, receiving capability change information sent by the UE forwarded by a third network device, wherein the capability change information includes capability information after AI capability of the UE changes.

Optionally, in this embodiment of the disclosure, receiving capability change information of the UE forwarded by a third network device includes at least one of the following: the third network device including a gNB, receiving the capability change information sent by the third network device via an NRPPa protocol;
the third network device including an LMF, receiving the capability change information sent by the third network device via the NRPPa protocol;
the third network device including an MN, receiving the capability change information forwarded by the third network device.

Optionally, in this embodiment of the disclosure, after successfully running or transmitting the AI model, AI capability information of the UE after the AI model is successfully run or transmitted is sent to a fourth network device.

The AI model processing method involved in this embodiment of the disclosure may include at least one of the foregoing steps and embodiments. For example, step 501 can be implemented as an independent embodiment, step 504 can be implemented as an independent embodiment, step 505 can be implemented as an independent embodiment, and step 506 can be implemented as an independent embodiment; the combination of steps 501, 502, and 503 can be implemented as an independent embodiment, but is not limited thereto.

In some embodiments, other optional implementations described before or after the specification corresponding to FIG. 5 may be referred to.

FIG. 6 is another schematic flowchart of the AI model processing method according to an embodiment of the disclosure.

As shown in FIG. 6, the method is applied to a UE, and the method includes:
step 601, receiving an AI model transmission request sent by a first network device, wherein the AI model transmission request includes parameter information of the AI model; and
step 602, feeding back an AI model transmission response to the first network device.

Optionally, in this embodiment of the disclosure, the AI model transmission response carries AI capability information of the UE, wherein the AI capability information includes: capability information of the UE to run the AI model, and/or capability information of the UE to store the AI model.

Optionally, in this embodiment of the disclosure, the parameter information includes at least one of the following:
identification information of the AI model, storage space information occupied by the AI model, or computational load information of the AI model.

Optionally, in this embodiment of the disclosure, the first network device includes a gNB, the AI model transmission request and/or AI model transmission response includes at least one of RRC signaling, MAC CE signaling, or physical layer signaling;
the first network device includes an LMF, the AI model transmission request and/or AI model transmission response includes LPP signaling;
the first network device includes OAM, the AI model transmission request is sent to the gNB via an MnS Consumer and sent to the UE via the gNB; the AI model transmission response is forwarded to the OAM via the GNB.

Optionally, in this embodiment of the disclosure, the AI model transmission response includes at least one of the following:
first identification information, identifying whether the UE rejects or accepts the AI model transmission request;
second identification information, identifying a reason why the UE rejects the AI model transmission request.

Optionally, in this embodiment of the disclosure, the AI capability information includes capability information of the UE before receiving the AI model, or capability information of the UE after receiving the AI model.

Optionally, in this embodiment of the disclosure, the method further includes:
sending capability change information of the UE to the first network device, wherein the capability change information includes capability information after AI capability of the UE changes upon receiving the AI model transmitted by another network device.

Optionally, in this embodiment of the disclosure,
the first network device includes a gNB, the capability change information is carried in at least one of RRC signaling, MAC CE signaling, or physical layer signaling;
the first network device includes an LMF, the capability change information is carried in LPP signaling;
the first network device or the third network device includes an OAM, the AI model transmission request is sent to the gNB via an MnS Consumer, and sent to the UE via the gNB; the AI model transmission response is forwarded to the OAM via the gNB.

Optionally, in this embodiment of the disclosure, the method includes:
sending capability change information of the UE to a third network device, indicating the third network device to forward the capability change information to a second network device, wherein the capability change information includes capability information after AI capability of the UE changes.

Optionally, in this embodiment of the disclosure, sending the capability change information of the UE to the third network device includes:
the third network device including a gNB, the capability change information carried in at least one of RRC signaling, MAC CE signaling, or physical layer signaling;
the third network device including an LMF, the capability change information carried in LPP signaling;
the third network device including OAM, the AI model transmission request is sent to the gNB via an MnS Consumer and sent to the UE via the gNB; the AI model transmission response is forwarded to the OAM via the gNB.

Optionally, in this embodiment of the disclosure, the AI capability information includes: capability information of the UE to run the AI model, and/or capability information of the UE to store the AI model.

The AI model processing method involved in this embodiment of the disclosure may include at least one of the foregoing steps and embodiments. For example, step 601 may be implemented as an independent embodiment, step 602 may be implemented as an independent embodiment; a combination of steps 601 and 602 may be implemented as an independent embodiment, but is not limited thereto.

In some embodiments, other optional implementations described before or after the specification corresponding to FIG. 6 may be referred to.

This disclosure also provides an AI model processing method applied to a first network device, including:
receiving capability change information sent by a user equipment (UE), wherein the capability change information includes capability information after AI capability of the UE changes upon receiving the AI model transmitted by another network device.

Optionally, in this embodiment of the disclosure, the AI capability information includes: capability information of the UE to run the AI model, and/or capability information of the UE to store the AI model.

Optionally, in this embodiment of the disclosure, the first network device includes a gNB, the capability change information is carried in at least one of RRC signaling, MAC CE signaling, or physical layer signaling;
the first network device includes an LMF, the capability change information is carried in LPP signaling;
the first network device includes OAM, the AI model transmission request is sent to the gNB via an MnS Consumer, and sent to the UE via the gNB; the AI model transmission response is forwarded to the OAM via the gNB.

The embodiment of this disclosure also provides an AI model processing method applied to a user equipment (UE), including:
sending capability change information of the UE to a first network device, after receiving an AI model transmitted by another network device, wherein the capability change information includes capability information after AI capability of the UE changes.

Optionally, in this embodiment of the disclosure, the AI capability information includes: capability information of the UE to run the AI model, and/or capability information of the UE to store the AI model.

Optionally, in this embodiment of the disclosure, the first network device includes a gNB, the capability change information is carried in at least one of RRC signaling, MAC CE signaling, or physical layer signaling;
the first network device includes an LMF, the capability change information is carried in LPP signaling;
the first network device or a third network device includes OAM, the AI model transmission request is sent to the gNB via an MnS Consumer, and sent to the UE via the gNB; the AI model transmission response is forwarded to the OAM via the gNB.

The embodiment of this disclosure also provides an AI model processing method applied to a first network device, including:
receiving capability change information of a user equipment (UE), and forwarding the capability change information to a second network device, wherein the capability change information includes capability information after AI capability of the UE changes.

Optionally, in this embodiment of the disclosure, forwarding the capability change information to the second network device includes at least one of the following:
the first network device including a gNB, sending the capability change information to the second network device via an NRPPa protocol;
the first network device including an LMF, sending the capability change information to the second network device via the NRPPa protocol;
the first network device including an MN, sending the capability change information to SN, LMF, and/or OAM.

Optionally, in this embodiment of the disclosure, the AI capability information includes: capability information of the UE to run the AI model, and/or capability information of the UE to store the AI model.

The embodiment of this disclosure also provides an AI model processing method applied to a user equipment (UE), including:
sending capability change information of the UE to a third network device, indicating the third network device to forward the capability change information to a second network device, wherein the capability change information includes capability information after AI capability of the UE changes.

Optionally, in this embodiment of the disclosure, sending the capability change information of the UE to the third network device includes:
the third network device including a gNB, the capability change information carried in at least one of RRC signaling, MAC CE signaling, or physical layer signaling;
the third network device including an LMF, the capability change information carried in LPP signaling;
the third network device including OAM, the AI model transmission request is sent to the gNB via an MnS Consumer and sent to the UE via the gNB; the AI model transmission response is forwarded to the OAM via the gNB.

Optionally, in this embodiment of the disclosure, the AI capability information includes: capability information of the UE to run the AI model, and/or capability information of the UE to store the AI model.

This embodiment of the disclosure also proposes an apparatus for implementing any of the above methods. For example, an apparatus is proposed, which includes units or modules for implementing the steps performed by the terminal in any of the above methods. For example, another apparatus is proposed, including units or modules for implementing the steps performed by network devices (e.g., access network devices, core network functional nodes, core network equipment, etc.) in any of the above methods.

It should be understood that the above division of units or modules in the apparatus is only a logical functional division; in actual implementation, they can be fully or partially integrated into a single physical entity, or they can be physically separated. Furthermore, the units or modules in the apparatus can be implemented in the form of a processor invoking software, for example, the apparatus includes a processor connected to a memory having instructions stored thereon, and the processor invokes the instructions stored in the memory to implement any of the above methods or to implement the functions of the above units or modules in the apparatus. The processor is, for example, a general-purpose processor, such as a Central Processing Unit (CPU) or a microprocessor, and the memory is either internal or external to the apparatus. Alternatively, the units or modules in the device can be implemented in the form of hardware circuits. The functions of some or all of the units or modules can be implemented through the design of the hardware circuits, which can be understood as one or more processors. For example, in one implementation, the hardware circuit is an application-specific integrated circuit (ASIC), and the functions of some or all of the units or modules are implemented through the design of the logical relationships between the components within the circuit. For another example, in another implementation, the hardware circuit can be implemented using a programmable logic device (PLD), such as a Field Programmable Gate Array (FPGA), which can include a large number of logic gates. The connection relationships between the logic gates are configured through a configuration file, thereby implementing the functions of some or all of the units or modules. All units or modules of the above apparatuses can be implemented entirely through the processor invoking software, or entirely through hardware circuits, or partially through the processor invoking software and the remaining through hardware circuits.

In embodiments of this disclosure, the processor is a circuit with signal processing capabilities. In one implementation, the processor can be a circuit with instruction reading and execution capabilities, such as a Central Processing Unit (CPU), a microprocessor, a graphics processing unit (GPU) (which can be understood as a microprocessor), or a digital signal processor (DSP). In another implementation, the processor can implement certain functions through the logical relationships of hardware circuits. The logical relationships of the hardware circuits are fixed or reconfigurable. For example, the processor is a hardware circuit implemented using an application-specific integrated circuit (ASIC) or a programmable logic device (PLD), such as an FPGA. In a reconfigurable hardware circuit, the process of the processor loading a configuration document and configuring the hardware circuit can be understood as the process of the processor loading instructions to implement the functions of some or all of the above-mentioned units or modules. Furthermore, it can also be a hardware circuit designed for artificial intelligence, which can be understood as an ASIC, such as a Neural Network Processing Unit (NPU), a Tensor Processing Unit (TPU), or a Deep Learning Processing Unit (DPU).

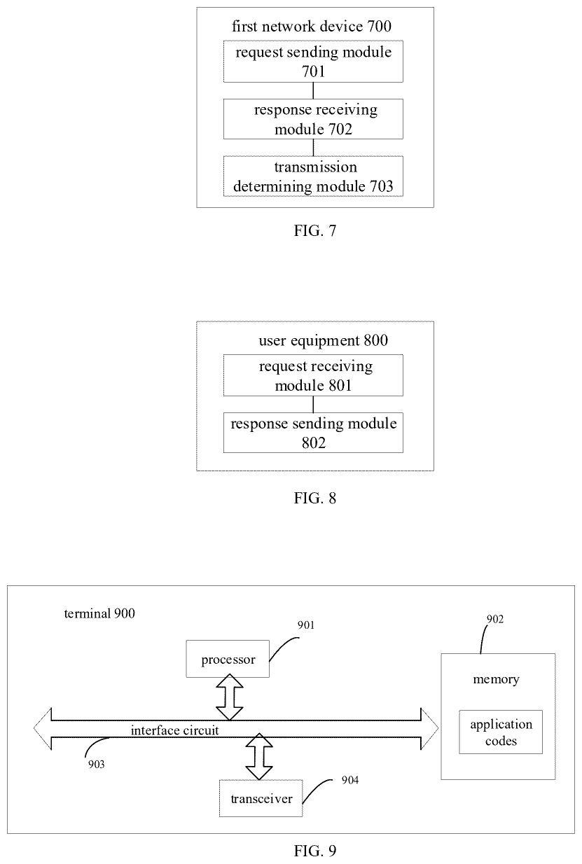

FIG. 7 is a schematic structural diagram of a first network device proposed by an embodiment of the present disclosure. As shown in FIG. 7, the first network device 700 may include at least one of a request sending module 701, a response receiving module 702, a transmission determining module 703, and the like.

In some embodiments, the request sending module 701 is configured to send an AI model transmission request to a user equipment (UE), wherein the AI model transmission request includes parameter information of the AI model; the response receiving module 702 is configured to receive an AI model transmission response fed back by the UE; and the transmission determining module 703 is configured to determine whether to transmit the AI model based on the AI model transmission response.

Optionally, the request sending module 701 is used to perform at least one of the communication steps (such as step 201 and step 501, but not limited thereto) performed by the first network device 101 in any of the above methods, and the response receiving module 702 is used to perform at least one of the communication steps (such as step 202 and step 502, but not limited thereto) performed by the first network device 101 in any of the above methods; the transmission determining module 703 is configured to perform at least one of the communication steps (e.g., step 203 and step 503, but not limited thereto) performed by the first network device 101 in any of the above methods, and will not be repeated here.

FIG. 8 is a schematic structural diagram of user equipment proposed by an embodiment of the present disclosure. As shown in FIG. 8, the user equipment 800 may include at least one of a request receiving module 801 and a response sending module 802.

In some embodiments, the request receiving module 801 is configured to receive an AI model transmission request sent by a first network device, wherein the AI model transmission request includes parameter information of the AI model; the response sending module 802 is configured to feed back an AI model transmission response to the first network device.

Optionally, the request receiving module 801 is used to perform at least one of the communication steps (such as step 401 and step 601, but not limited thereto) performed by the UE102 in any of the above methods, and the response sending module 802 is used to perform at least one of the communication steps (such as step 402 and step 602, but not limited thereto) performed by the UE102 in any of the above methods, which will not be described here.

FIG. 9 is a schematic structural diagram of a terminal 900 (e.g., the UE or the like) proposed in an embodiment of this disclosure. The terminal 900 may be a chip, a chip system, or a processor that supports the network device to implement any of the above methods, or may be a chip, a chip system, or a processor that supports the terminal to implement any of the above methods. The terminal 900 can be used to implement the methods described in the above method embodiments, and specific details can be found in the descriptions of the above method embodiments.

As shown in FIG. 9, the terminal 900 includes one or more processors 901. The processor 901 can be a general-purpose processor or a dedicated processor, such as a baseband processor or a central processor. The baseband processor can be used to process communication protocols and communication data, and the central processor can be used to control communication apparatuses (e.g., base stations, baseband chips, terminal devices, terminal device chips, DUs or CUs, etc.), execute programs, and process program data. The terminal 900 is used to execute any of the above methods.

In some embodiments, the terminal 900 further includes one or more memories 902 for storing instructions. Optionally, all or part of the memories 902 may be located external to the terminal 900.

In some embodiments, the terminal 900 further includes one or more transceivers 904. When the terminal 900 includes one or more transceivers 904, the transceiver 904 performs at least one of the communication steps, such as sending and/or receiving, in the above method, for example, step 201, step 202, step 301, step 401, step 402, step 501, step 502, step 504, step 505, step 506, step 601, step 602, but not limited thereto. The processor 901 performs at least one of the other steps, such as step 203, step 503, but not limited thereto.

In some embodiments, a transceiver may include a receiver and/or a transmitter, which may be separate or integrated. Optionally, the terms transceiver, transceiver unit, transceiver machine, and transceiver circuit can be used interchangeably; the terms transmitter, transmitting unit, transmitter machine, and transmitting circuit can be used interchangeably; and the terms receiver, receiving unit, receiver machine, and receiving circuit can be used interchangeably.

In some embodiments, the terminal 900 may include one or more interface circuits 903. Optionally, the interface circuit 903 is connected to the memory 902 and can be used to receive signals from the memory 902 or other apparatuses, and to send signals to the memory 902 or other apparatuses. For example, the interface circuit 903 can read instructions stored in the memory 902 and send the instructions to the processor 901.

The terminal 900 described in the above embodiments may be a communication device, such as the UE, but the scope of the terminal 900 described in this disclosure is not limited thereto, and the structure of the terminal 900 may not be limited to FIG. 9. The terminal may be a standalone device or may be part of a large device. For example, the terminal may be: (1) a standalone integrated circuit (IC), or a chip, or a chip system or a subsystem; (2) a collection of one or more ICs, optionally including storage components for storing data and programs; (3) an ASIC, such as a modem; (4) a module that can be embedded in other devices; (5) a receiver, a terminal device, a smart terminal device, a cellular phone, a wireless device, a handheld device, a mobile unit, a vehicle-mounted device, a network device, a cloud device, an artificial intelligence device, etc. ; (6) others, etc.

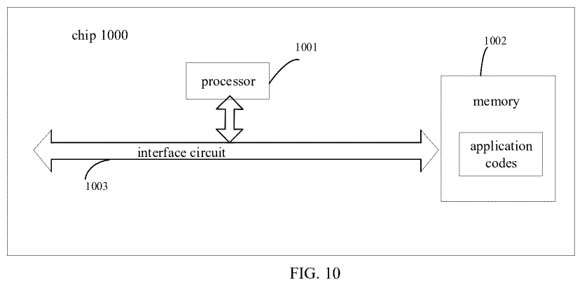

FIG. 10 is a schematic diagram of the structure of chip 1000 according to an embodiment of this disclosure. For the case that the terminal 900 can be a chip or a chip system, it can refer to the structural schematic diagram of the chip 1000 shown in FIG. 10, but it is not limited to this. The chip 1000 includes one or more processors 1001, and the chip 1000 is used to perform any of the above methods.

In some embodiments, the chip 1000 further includes one or more interface circuits 1003. Optionally, the interface circuit 1003 is connected to the memory 1002. The interface circuit 1003 can be used to receive signals from the memory 1002 or other apparatuses, and can also be used to send signals to the memory 1002 or other apparatuses. For example, the interface circuit 1003 can read instructions stored in the memory 1002 and send these instructions to the processor 1001.

In some embodiments, the interface circuit 1003 performs at least one of the communication steps, such as sending and/or receiving, in the above method, for example, step 201, step 202, step 301, step 401, step 402, step 501, step 502, step 504, step 505, step 506, step 601, step 602, but not limited thereto. The processor 1001 performs at least one of the other steps, such as step 203, step 503, but not limited thereto.

In some embodiments, the terms interface circuit, interface, transceiver pin, transceiver, etc., can be used interchangeably.

In some embodiments, the chip 1000 further includes one or more memories 1002 for storing instructions. Optionally, all or part of the memories 1002 may be located external to the chip 1000.

This disclosure also provides a storage medium storing instructions that, when executed on a terminal 900, cause the terminal 900 to perform any of the above methods. Optionally, the storage medium is an electronic storage medium. Optionally, the storage medium is a computer-readable storage medium, but not limited thereto; it may also be a storage medium readable by other apparatuses. Optionally, the storage medium may be a non-transitory storage medium, but not limited thereto; it may also be a transitory storage medium.

This disclosure also provides a program product that, when executed by the terminal 900, causes the terminal 900 to perform any of the above methods. Optionally, the program product is a computer program product.

This disclosure also provides a computer program that, when executed on a computer, causes the computer to perform any of the above methods.

1. An AI model processing method, applied to a first network device, the method comprising:
sending an artificial intelligence (AI) model transmission request to a user equipment (UE), wherein the AI model transmission request comprises parameter information of the AI model;
receiving an AI model transmission response fed back by the UE; and
determining whether to transmit the AI model based on the AI model transmission response.

2. The AI model processing method according to claim 1, wherein the parameter information comprises at least one of the following:
identification information of the AI model, storage space information occupied by the AI model, or computational load information of the AI model.

3. The AI model processing method according to claim 1, wherein the AI model transmission response carries AI capability information of the UE, wherein the AI capability information comprises: capability information of the UE to run
the AI model, and/or capability information of the UE to store the AI model, wherein the AI capability information comprises capability information of the UE before receiving the AI model, or capability information of the UE after receiving the Al model.

4. (canceled)

5. The AI model processing method according to claim 1, wherein,
the first network device comprises a gNB, the AI model transmission request and/or AI model transmission response comprises at least one of Radio Resource Control (RRC) signaling, MAC Control Element (MAC CE) signaling, or physical layer signaling;
the first network device comprises a Location Management Function (LMF), the Al model transmission request and/or AI model transmission response comprises LTE Positioning Protocol (LPP) signaling;
the first network device comprises Operation, Administration and Maintenance (OAM), the AI model transmission request is sent to the gNB via an MnS Consumer and sent to the UE via the gNB; the AI model transmission response is forwarded to the OAM via the gNB.

6. The AI model processing method according to claim 1, wherein the AI model transmission response comprises at least one of the following:
first identification information, identifying whether the UE rejects or accepts the Al model transmission request;
second identification information, identifying a reason why the UE rejects the Al model transmission request.

7. The AI model processing method according to claim 1, further comprising:
receiving capability change information sent by the UE, wherein the capability change information comprises capability information after AI capability of the UE changes upon receiving the AI model transmitted by another network device, wherein,
the first network device comprises a gNB, the capability change information is carried in at least one of RRC signaling, MAC CE signaling, or physical layer signaling;
the first network device comprises an LMF, the capability change information is carried in LPP signaling;
the first network device comprises OAM, the capability change information is carried in RRC signaling.

8. (canceled)

9. The AI model processing method according to claim 1, further comprising:
receiving capability change information sent by the UE, and forwarding the capability change information to a second network device, wherein the capability change information comprises capability information after AI capability of the UE changes, wherein forwarding the capability change information to the second network device comprises at least one of the following:
the first network device comprising a gNB, sending the capability change information to the second network device via an NRPPa protocol;
the first network device comprising an LMF, sending the capability change information to the second network device via the NRPPa protocol;
the first network device comprising a master node MN, sending the capability change information to secondary nodes SN, LMF, and/or OAM.

10. (canceled)

11. The AI model processing method according to claim 1, further comprising:
receiving capability change information sent by the UE forwarded by a third network device, wherein the capability change information comprises capability information after AI capability of the UE changes,
wherein receiving capability change information of the UE forwarded by a third network device comprises at least one of the following:
the third network device comprising a gNB, receiving the capability change information sent by the third network device via an NRPPa protocol;
the third network device comprising an LMF, receiving the capability change information sent by the third network device via the NRPPa protocol;
the third network device comprising an MN, receiving the capability change information forwarded by the third network device.

12. (canceled)

13. The AI model processing method according to claim 1, further comprising:
after successfully running or transmitting the AI model, sending AI capability information of the UE after the AI model is successfully run or transmitted to a fourth network device.

14. An AI model processing method, applied to a user equipment (UE), the method comprising:
receiving an AI model transmission request sent by a first network device, wherein the AI model transmission request comprises parameter information of the AI model; and
feeding back an AI model transmission response to the first network device.

15. The AI model processing method according to claim 14, wherein,
the AI model transmission response carries AI capability information of the UE, wherein the AI capability information comprises: capability information of the UE to run the AI model, and/or capability information of the UE to store the AI model.

16. The AI model processing method according to claim 14, wherein the parameter information comprises at least one of the following:
identification information of the AI model, storage space information occupied by the AI model, or computational load information of the AI model.

17. The AI model processing method according to claim 14, wherein,
the first network device comprises a gNB, the AI model transmission request and/or AI model transmission response comprises at least one of RRC signaling, MAC CE signaling, or physical layer signaling;
the first network device comprises an LMF, the AI model transmission request and/or AI model transmission response comprises LPP signaling;
the first network device comprises OAM, the AI model transmission request is sent to the gNB via an MnS Consumer and sent to the UE via the gNB; the AI model transmission response is forwarded to the OAM via the gNB.

18. The AI model processing method according to claim 14, wherein the AI model transmission response comprises at least one of the following:
first identification information, identifying whether the UE rejects or accepts the Al model transmission request;
second identification information, identifying a reason why the UE rejects the Al model transmission request.

19. The AI model processing method according to claim 15, wherein the AI capability information comprises capability information of the UE before receiving the AI model, or capability information of the UE after receiving the AI model.

20. The AI model processing method according to claim 14, further comprising:
sending capability change information of the UE to the first network device, wherein the capability change information comprises capability information after AI capability of the UE changes upon receiving the AI model transmitted by another network device, wherein,
the first network device comprises a gNB, the capability change information is carried in at least one of RRC signaling, MAC CE signaling, or physical layer signaling;
the first network device comprises an LMF, the capability change information is carried in LPP signaling;
the first network device comprises OAM, the capability change information is carried in RRC signaling.

21. (canceled)

22. The AI model processing method according to claim 14, further comprising:
sending capability change information of the UE to a third network device, indicating the third network device to forward the capability change information to a second network device, wherein the capability change information comprises capability information after AI capability of the UE changes, wherein sending the capability change information of the UE to the third network device comprises:
the third network device comprising a gNB, the capability change information carried in at least one of RRC signaling, MAC CE signaling, or physical layer signaling;
the third network device comprising an LMF, the capability change information carried in LPP signaling;
the third network device comprising OAM, the capability change information carried in RRC signaling.

23. (canceled)

24. The AI model processing method according to claim 19, wherein the AI capability information comprises: capability information of the UE to run the AI model, and/or capability information of the UE to store the AI model.

25. An AI model processing method, applied to a first network device, the method comprising:
receiving capability change information sent by a user equipment (UE), wherein the capability change information comprises capability information after AI capability of the UE changes upon receiving the AI model transmitted by another network device.

26-38. (canceled)

39. A network device, the network device being a first network device, and comprising:
one or more processors,
wherein the network device is configured to execute the AI model processing method according to claim 1.

40-42. (canceled)
